(19) United States
(12) Patent Application Publication
(10) Pub. No.: US 2020/0298793 A1
(43) Pub. Date: Sep. 24, 2020

(54) PRETENSIONER, RETRACTOR, AND SEAT BELT DEVICE

(71) Applicant: JOYSON SAFETY SYSTEMS JAPAN K.K., Tokyo (JP)

(72) Inventors: Kiyoshi WATANABE, Shiga (JP); Tadayuki ASAKO, Shiga (JP)

(73) Assignee: JOYSON SAFETY SYSTEMS JAPAN K.K., Tokyo (JP)

(21) Appl. No.: 16/651,234

(22) PCT Filed: Oct. 26, 2018
(86) PCT No.: PCT/JP2018/039799

§ 371 Date: Mar. 26, 2020

(30) Foreign Application Priority Data
Nov. 13, 2017 (JP) 2017-217920

(51) Int. Cl. B60R 22/46

(52) U.S. Cl. CPC B60R 22/46; B60R 2022/468

(57) ABSTRACT

Provided are a pretensioner, a retractor, and a seat belt device which can achieve both securing of the strength of a power transmission member in an initial driving stage and reduction of the sliding resistance against the power transmission member in a steady driving stage. The retractor 1 includes a spool 2 for winding up webbing for restraining an occupant and a pretensioner 3 for winding up the webbing in an emergency to remove slack. The pretensioner 3 includes a ring gear 31 connected to the spool 2 and a power transmission device 32 for transmitting power to the ring gear 31 in an emergency. The power transmission device 32 includes a rod-shaped power transmission member 32a which transmits power to the ring gear 31 while being plastically deformed. A tip end of the power transmission member 32a has an enlarged portion 32b formed thicker than other portions of the power transmission member 32a. The enlarged portion 32b is made of the same material as the power transmission member 32a.

### TECHNICAL FIELD

The present invention relates to a pretensioner, a retractor, and a seat belt device, and more particularly to a pretensioner, a retractor, and a seat belt device suitable for a configuration including a rod-shaped power transmission member.

### BACKGROUND ART

Generally, a vehicle such as an automobile is provided with a seat belt device which restrains an occupant on a seat including a seat portion on which the occupant sits and a backrest portion located on the back of the occupant. Such a seat belt device includes a webbing for restraining an occupant, a retractor for winding the webbing, a buckle disposed on a side surface of the seat, and a tongue disposed on the webbing, and by fitting the tongue to the buckle, the occupant is restrained to the seat by the webbing. Also, it has become common for the retractor to have a pretensioner for removing slack in the webbing in an emergency such as a vehicle collision (for example, see Patent Literature 1).

The pretensioner described in Patent Literature 1 includes a ring gear (24) arranged in a spool (14) for winding webbing and a power transmission means (16) for transmitting power to the ring gear (24) in an emergency. The power transmission means (16) includes a rod-shaped power transmission member (22) which transmits power to the ring gear (24) while plastically deforming, a pipe (20) accommodating the power transmission member (22), and a gas generator (18) located at the end portion of the pipe (20).

### CITATION LIST

### Patent Literature

[Patent Literature 1]: International Publication No. 2012/143090

### SUMMARY OF INVENTION

### Technical Problem

The pretensioner employing the rod-shaped power transmission member as described in Patent Literature 1 has the highest load when the power transmission member first collides with the ring gear in an initial driving stage. Therefore, the power transmission member needs a predetermined thickness (strength). On the other hand, when the entire rod member is made thicker, the number of engagement teeth of the ring gear with respect to the power transmission member increases with the transition to a steady drive stage. Thus, the resistance when the power transmission member slides inside the pipe will increase.

The invention has been made in view of such a problem and an object thereof is to provide a pretensioner, a retractor, and a seat belt device which can achieve both securing of the strength of a power transmission member in an initial driving stage and reduction of the sliding resistance against the power transmission member in a steady driving stage.

### Solution to Problem

According to an aspect of the invention, there is provided a pretensioner which includes a ring gear connected to a spool which winds webbing to restrain an occupant and a power transmission device which transmits power to the ring gear in an emergency, in which the power transmission device includes a rod-shaped power transmission member which transmits power to the ring gear while plastically deforming and a tip end of the power transmission member has an enlarged portion formed thicker than other portions of the power transmission member, and further the enlarged portion is made of the same material as the power transmission member.

According to another aspect of the invention, there is provided a retractor which includes a spool which winds webbing for restraining an occupant and a pretensioner which winds the webbing to remove slack in an emergency, where the pretensioner includes a ring gear connected to the spool and a power transmission device which transmits power to the ring gear in an emergency and the power transmission device includes a rod-shaped power transmission member which transmits power to the ring gear while plastically deforming, and further a tip end of the power transmission member has an enlarged portion formed thicker than other portions of the power transmission member, and still further the enlarged portion is made of the same material as the power transmission member.

According to still another aspect of the invention there is provided a seat belt device which includes webbing for restraining an occupant and a retractor for winding the webbing, where the retractor includes a ring gear connected to the spool and a power transmission device which transmits power to the ring gear in an emergency and the power transmission device includes a rod-shaped power transmission member which transmits power to the ring gear while plastically deforming, and further a tip end of the power transmission member has an enlarged portion formed thicker than other portions of the power transmission member, and still further the enlarged portion includes a pretensioner made of the same material as the power transmission member.

In the above-described pretensioner, retractor and seat belt device, the enlarged portion may be formed such that a length in an axial direction of the power transmission member is smaller than a pitch of the ring gear.

Further, the pretensioner may include a guide block arranged at a meshing start portion between the ring gear and the power transmission member and the guide block may have a slope for guiding movement of the power transmission member and a main body portion fixed to a base frame surrounding the spool.

### Advantageous Effects of Invention

According to the above-described pretensioner, retractor, and seat belt device of the invention, by forming the enlarged portion at the tip end of the power transmission member, the enlarged portion first collides with the ring gear when the pretensioner is operated. Thus, the thick portion of the power transmission member can collide with the ring gear in the initial driving stage. As a result, the strength of the power transmission member can be secured. In addition, since the portion behind the enlarged portion of the power transmission member is formed thinner than the enlarged portion, the engagement depth of the ring gear in the steady driving stage can be reduced. As a result, the resistance accompanying the increase in the number of engagement teeth can be reduced.

Therefore, according to the invention, it is possible to achieve both the securing of the strength of the power transmission member in the initial driving stage and the reduction of the sliding resistance against the power transmission member in the steady driving stage.

### BRIEF DESCRIPTION OF DRAWINGS

FIG. 1 is an exploded view of components illustrating a retractor according to an embodiment of the invention.

FIGS. 2A and 2B are cross-sectional views of a pretensioner illustrated in FIG. 1, where FIG. 2A illustrates a non-operating state and FIG. 2B illustrates an enlarged view of a tip end of a power transmission member.

FIGS. 3A and 3B are cross-sectional views of the pretensioner illustrated in FIG. 1, where FIG. 3A illustrates an initial operation state and FIG. 3B illustrates an intermediate operation stage.

FIGS. 4A to 4E are views illustrating modification examples of an enlarged portion, where FIG. 4A illustrates a first modification example, FIG. 4B illustrates a second modification example, FIG. 4C illustrates a third modification, FIG. 4D illustrates a fourth modification, and FIG. 4E illustrates a fifth modification example.

FIG. 5A to 5E are views illustrating modification examples of the enlarged portion, where FIG. 5A illustrates a sixth modification example, FIG. 5B illustrates a seventh modification example, FIG. 5C illustrates an eighth modification example, FIG. 5D illustrates a ninth modification example, and FIG. 5E illustrates a tenth modification example.

FIG. 6 is an overall configuration diagram illustrating a seat belt device according to the embodiment of the invention.

### DESCRIPTION OF EMBODIMENTS

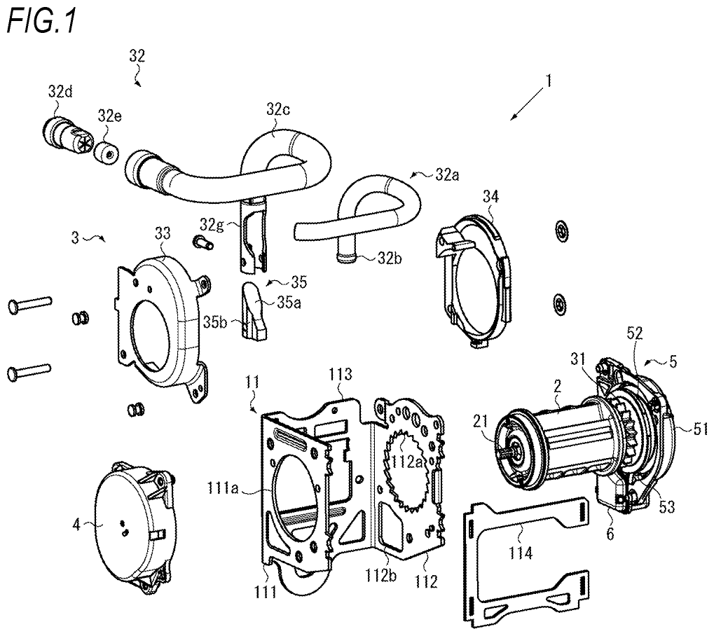

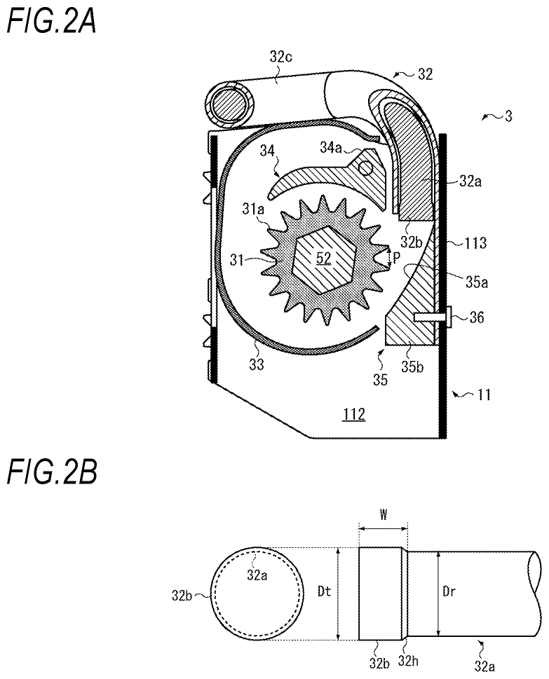

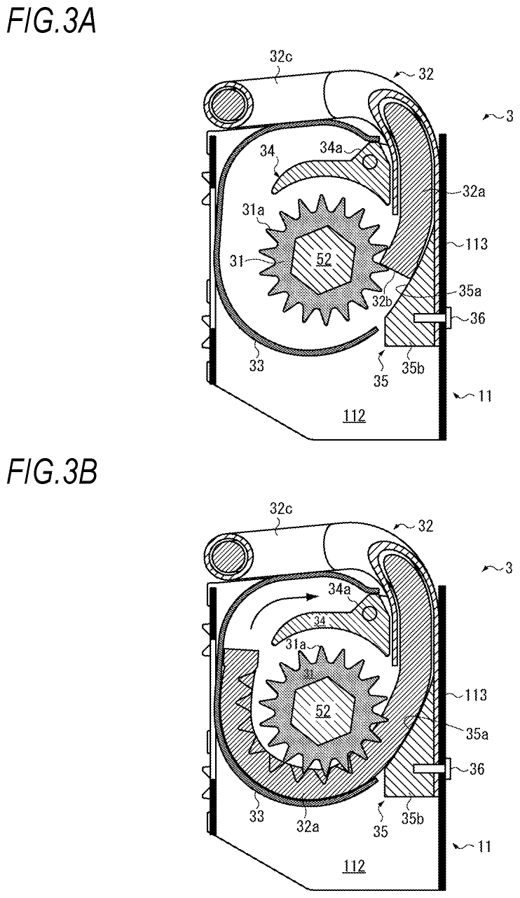

Hereinafter, embodiments of the invention will be described with reference to FIGS. 1 to 6. Here, FIG. 1 is an exploded view of components illustrating a retractor according to an embodiment of the invention. FIGS. 2A and 2B are cross-sectional views of a pretensioner illustrated in FIG. 1, where FIG. 2A illustrates a non-operating state and FIG. 2B illustrates an enlarged view of a tip end of a power transmission member. FIGS. 3A and 3B are cross-sectional views of the pretensioner illustrated in FIG. 1, where FIG. 3A illustrates an initial operation state and FIG. 3B illustrates an intermediate operation stage. In FIG. 2B, the left diagram illustrates a front view of the power transmission member and the right diagram illustrates a partial side view of the power transmission member.

As illustrated in FIG. 1, a retractor 1 according to an embodiment of the invention includes a spool 2 which winds up a webbing which restrains an occupant and a pretensioner 3 which winds up webbing in an emergency to remove slack. The pretensioner 3 includes a ring gear 31 connected to the spool 2 and a power transmission device 32 which transmits power to the ring gear 31 in an emergency. The power transmission device 32 includes a rod-shaped power transmission member 32a which transmits power to the ring gear 31 while being plastically deformed. A tip end of the power transmission member 32a has an enlarged portion 32b which is formed thicker than other portions of the power transmission member 32a. The enlarged portion 32b is made of the same material as the power transmission member 32a. In FIG. 1, the illustration of the webbing is omitted.

The spool 2 is a winding drum which winds up the webbing and is rotatably accommodated in a base frame 11 which forms a skeleton of the retractor 1. The base frame 11 has, for example, a pair of end surfaces 111 and 112 facing each other and a side surface 113 connecting these end surfaces. The base frame 11 may have a tie plate 114 facing the side surface 113 and connected to the end surfaces 111 and 112. Further, for example, a spring unit 4 is arranged on the end face 111 side and the pretensioner 3 and a lock mechanism 5 are arranged on the end face 112 side. The arrangement of the spring unit 4, the pretensioner 3, the lock mechanism 5, and the like is not limited to the illustrated configuration.

An opening portion 111a is formed in the end surface 111 of the base frame 11 to insert the shaft portion of the spool 2 and the end surface 112 of the base frame 11 is formed with an opening portion 112a having internal teeth which can be engaged with a pawl (not illustrated) of the lock mechanism 5. A part (for example, the ring gear 31) of the pretensioner 3 is arranged inside the end surface 112 of the base frame 11. Further, the lock mechanism 5 is disposed outside the end surface 112 of the base frame 11 and the lock mechanism 5 is accommodated in a retainer cover 51.

The retainer cover 51 may be provided with a vehicle sensor 6 for detecting sudden deceleration or inclination of a vehicle body. The vehicle sensor 6 has, for example, a spherical mass body and a sensor lever which is swung by the movement of the mass body. The vehicle sensor 6 is fitted and fixed in the opening portion 112b formed on the end surface 112 of the base frame 11.

The spool 2 has a cavity in the center portion and a torsion bar 21 forming an axis may be inserted therethrough. The torsion bar 21 has a first end portion connected to a locking base 52 of the lock mechanism 5 connected to an end portion of the spool 2 and a second end portion connected to a spring core of the spring unit 4. Therefore, the spool 2 is connected to the spring unit 4 via the locking base 52 and the torsion bar 21 and is urged by a power spring accommodated in the spring unit 4 in a direction of winding the webbing.

The first end portion of the torsion bar 21 may be connected to the spool 2 without passing through the locking base 52. The means for applying the winding force to the spool 2 is not limited to the spring unit 4, but may be another means using an electric motor or the like.

The locking base 52 is provided with a pawl arranged so as to be able to protrude or emerge from the side surface portion. When the lock mechanism 5 is operated, by protruding the pawl from the side surface portion of the locking base 52, the pawl is engaged with the internal teeth formed in the opening portion 112a of the base frame 11, in such a manner that the rotation of the locking base 52 in a webbing withdrawal direction is restricted.

Therefore, even when a load is applied in the webbing withdrawal direction in a state where the lock mechanism 5 is operated, until a load equal to or greater than a threshold value is applied to the torsion bar 21, the spool 2 can be kept in a non-rotating state. When a load equal to or greater than the threshold value is applied to the torsion bar 21, the torsion bar 21 is twisted, so that the spool 2 relatively rotates and the webbing is pulled out.

Further, the lock mechanism 5 includes a lock gear 53 arranged so as to be adjacent to the locking base 52. The lock gear 53 includes a flywheel (not illustrated) which is swingably disposed. When the speed of the webbing is faster than a normal withdrawal speed, the flywheel swings and engages with the internal teeth (not illustrated) formed on the retainer cover 51. When the vehicle sensor 6 is operated, the sensor lever engages with external teeth formed on the side surface of the lock gear 53.

Thus, in the case of the lock gear 53, the rotation of the lock gear 53 is regulated by the operation of the flywheel or the vehicle sensor 6. When the rotation of the lock gear 53 is restricted, relative rotation occurs between the locking base 52 and the lock gear 53 and the pawl protrudes from the side surface portion of the locking base 52 with the relative rotation.

In addition, the lock mechanism 5 is not limited to the configuration illustrated in the drawing and various configurations existing in the related art can be arbitrarily selected and used.

The pretensioner 3 includes, for example, the ring gear 31 arranged coaxially with the spool 2, the power transmission device 32 for rotating the ring gear 31, a pretensioner cover 33 for accommodating the ring gear 31, a guide spacer 34 forming a moving space for the power transmission member 32a, and a guide block 35 arranged at the start point of engagement between the ring gear 31 and the power transmission member 32a.

The pretensioner cover 33 is arranged inside the end surface 112 of the base frame 11 and the guide spacer 34 is accommodated in the pretensioner cover 33. The ring gear 31 is arranged such that the ring gear 31 is located in the space between the pretensioner cover 33 and the end surface 112 secured by the guide spacer 34.

The ring gear 31 is fixed to, for example, a shaft portion of the locking base 52. As illustrated in FIG. 2A, the ring gear 31 has a plurality of engagement teeth 31a formed to protrude radially outward. In addition, the ring gear 31 may be called a pinion gear.

The power transmission device 32 includes, for example, the rod-shaped power transmission member 32a which transmits power to the ring gear 31 while plastically deforming, a pipe 32c for accommodating the power transmission member 32a, a gas generator 32d disposed at an end portion of the pipe 32c, and a piston 32e sliding in the pipe 32c.

In the pipe 32c, a tip end is located at a position facing the engagement teeth 31a of the ring gear 31 and a rear end side is extended by the length necessary for the movement of the power transmission member 32a. Also, the pipe 32c is formed so as to be curved along the outer shape of the retractor 1. As illustrated in FIG. 1, an opening portion 32g is formed at a part of the outer periphery of the tip end of the pipe 32c and the power transmission member 32a is discharged into the pretensioner cover 33 from the opening portion 32g.

Also, as illustrated in FIG. 2A, the guide block 35 is inserted into the tip end of the pipe 32c and the guide block 35 and the tip end of the pipe 32c are fixed to the side surface 113 of the base frame 11 by a fixing pin 36. The guide block 35 has a slope 35a for guiding the movement of the power transmission member 32a and a main body portion 35b fixed to the base frame 11 (side surface 113).

As illustrated in FIG. 1, the guide block 35 has a columnar shape which can be inserted into the tip end of the pipe 32c and has the slope 35a formed on its end surface. The guide block 35 is a component which guides the tip end of the power transmission member 32a to collide with the engagement teeth 31a of the ring gear 31 when the pretensioner 3 is operated. The slope 35a may be flat or curved as long as the slope 35a can guide the power transmission member 32a.

The guide block 35 is also a component which receives an impact generated when the power transmission member 32a collides with the engagement teeth 31a. Therefore, the guide block 35 may be made of resin or metal as long as the guide block 35 has enough strength to withstand the load generated when the power transmission member 32a collides with the engagement teeth 31a. The guide block 35 is fixed to the base frame 11 having high strength by the fixing pin 36. Therefore, the power transmission member 32a can be guided to the ring gear 31 without being deformed or displaced when the pretensioner 3 is operated, and without escaping the power transmission member 32a.

The power transmission member 32a has, for example, an elongated shape (rod shape) made of resin and is accommodated in the pipe 32c. As illustrated in FIG. 2B, in the power transmission member 32a, the enlarged portion 32b formed thicker than other portions of the power transmission member 32a is provided at the tip end. The enlarged portion 32b is obtained by enlarging the tip end of the power transmission member 32a and is made of the same material as the power transmission member 32a. A transition portion 32h between the enlarged portion 32b and another portion may have a tapered surface.

Here, assuming that the thickness of the portion other than the enlarged portion 32b of the power transmission member 32a is set as Dr and the thickness of the enlarged portion 32b is set as Dt, the power transmission member 32a has a relationship of Dt>Dr. The difference (the magnitude of Dt−Dr) between the enlarged portion 32b and the other portions is set to, for example, about 10% to 15% of Dr.

The enlarged portion 32b is formed such that the length in the axial direction of the power transmission member 32a is smaller than the pitch (the distance between the tip end portions of the adjacent engagement teeth 31a) of the ring gear 31. Specifically, assuming that the axial length of the enlarged portion 32b is set as W and the pitch of the ring gear 31 is set as P, the enlarged portion 32b has a relationship of W<P. With this configuration, interference between the enlarged portion 32b and the engagement teeth 31a can be avoided.

The power transmission device 32 having the enlarged portion 32b is normally (when the pretensioner 3 is not operated) kept in a state where the power transmission member 32a is accommodated in the pipe 32c as illustrated in FIG. 2A. In an emergency (when the pretensioner 3 is operating) such as a vehicle collision, the power transmission member 32a is pushed out of the pipe 32c by the gas supplied by the gas generator 32d.

The power transmission member 32a pushed out of the pipe 32c moves along the slope 35a of the guide block 35 and collides with the engagement teeth 31a of the ring gear 31, as illustrated in FIG. 3A. In this case, since the enlarged portion 32b first collides with the engagement teeth 31a of the ring gear 31, the thick portion of the power transmission member 32a can collide with the ring gear 31 in the initial driving stage. As a result, the strength of the power transmission member 32a can be secured.

Then, as illustrated in FIG. 3B, the power transmission member 32a is pushed out into a space (passage) formed by the pretensioner cover 33 and the guide spacer 34 and moves along the passage while engaging with the engagement teeth 31a of the ring gear 31. In this case, about 4 to 5 engagement teeth 31a are engaged with the power transmission member 32a and the ring gear 31 is rotating and a stage in which a state is shifted to that state is referred to as a steady driving stage.

In such a steady driving stage, since the enlarged portion 32b of the power transmission member 32a has passed through the ring gear 31, the ring gear 31 engages with other portions of the power transmission member 32a other than the enlarged portion 32b. The other portion behind the enlarged portion 32b is formed thinner than the enlarged portion 32b, so that the engagement depth of the engagement teeth 31a can be reduced. Therefore, the resistance caused by the increase in the number of engagement teeth of the ring gear 31 can be reduced.

Then, the power transmission member 32a finally stops by colliding with a stopper surface 34a formed by the guide spacer 34 or finishing winding up the slack of the webbing.

In the embodiment, a case where the pretensioner 3 has the guide block 35 is described, but the power transmission member 32a having the enlarged portion 32b can be applied to a pretensioner of the related art which does not have the guide block.

In this embodiment, the “tip end” of the power transmission member 32a or the pipe 32c means the end portion of the power transmission member 32a on a movement-direction front side (the side close to the engagement teeth 31a of the ring gear 31) when the pretensioner 3 operates and the “rear end” of the power transmission member 32a or the pipe 32c means the end portion of the power transmission member 32a on a movement-direction rear side (the side close to the gas generator 32d) when the pretensioner 3 is operated.

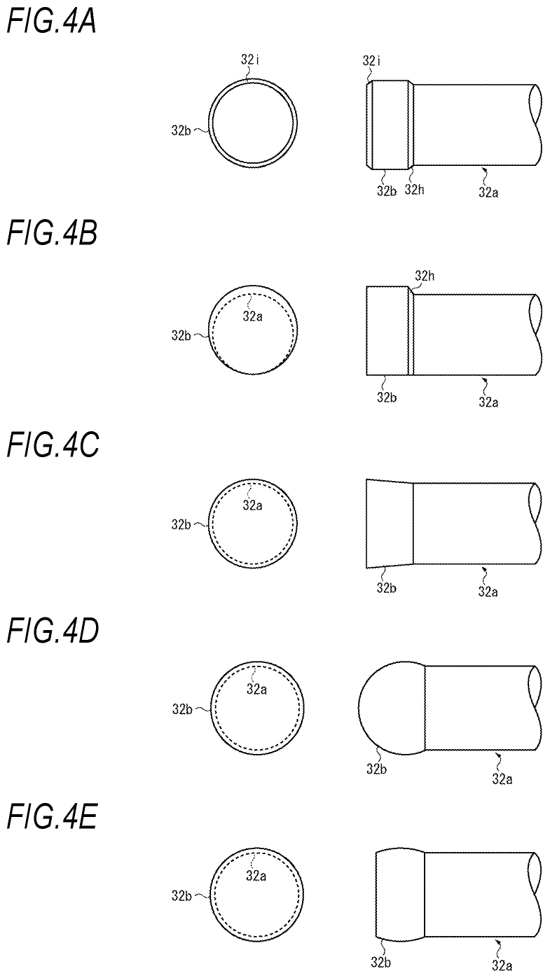

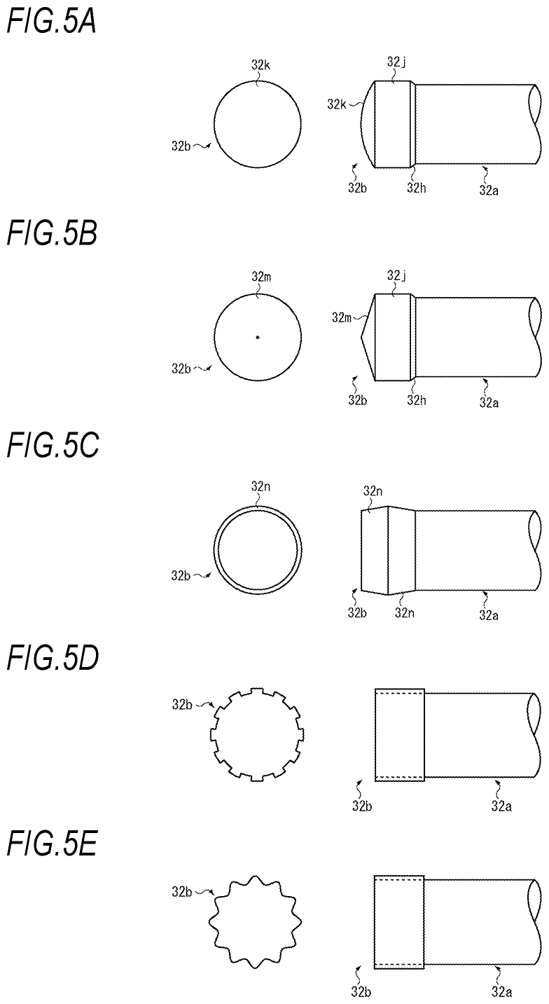

Next, modification examples of the enlarged portion 32b will be described with reference to FIGS. 4A to 4D. Here, FIGS. 4A to 4E are views illustrating modification examples of the enlarged portion, where FIG. 4A illustrates a first modification example, FIG. 4B illustrates a second modification example, FIG. 4C illustrates a third modification example, FIG. 4D illustrates a fourth modification example, and FIG. 4E illustrates a fifth modification example. FIGS. 5A to 5E are views illustrating the modification examples of the enlarged portion, where FIG. 5A illustrates a sixth modification example, FIG. 5B illustrates a seventh modification example, FIG. 5C illustrates an eighth modification example, FIG. 5D illustrates a ninth modification example, and FIG. 5E illustrates a tenth modification example. In each of FIGS. 4A to 5E, the left diagram is a front view of the power transmission member 32a and the right diagram is a partial side view of the power transmission member 32a.

In the first modification example illustrated in FIG. 4A, a tapered surface is formed (chamfered) at an outer peripheral edge portion 32i of the enlarged portion 32b. According to the first modification example, the slidability of the power transmission member 32a can be improved.

In the second modification example illustrated in FIG. 4B, the enlarged portion 32b is eccentric with respect to the other portion of the power transmission member 32a. Thus, even when the enlarged portion 32b is eccentric, it can be formed thicker than the other portions. Also, by arranging the side (the lower side in the figure) where the transition portion 32h of the enlarged portion 32b is flat on the guide block 35 side and arranging the side where the transition portion 32h protrudes on the ring gear 31 side, the slidability of the power transmission member 32a can be improved.

In the third modification example illustrated in FIG. 4C, the enlarged portion 32b is formed in a truncated cone shape. In the fourth modification example illustrated in FIG. 4D, the enlarged portion 32b is formed in a substantially spherical shape. In the fifth modification example illustrated in FIG. 4E, the enlarged portion 32b is formed in a shape in which both end portions of spheres bodies are cut off.

In the sixth modification example illustrated in FIG. 5A, the enlarged portion 32b is formed by a cylindrical portion 32j and a spherical portion 32k. In the seventh modification example illustrated in FIG. 5B, the enlarged portion 32b is formed by the cylindrical portion 32j and a conical portion 32m. In the eighth modification example illustrated in FIG. 5C, the enlarged portion 32b is formed in a shape in which bottom portions of a pair of frustoconical portions 32n are in contact with each other.

In the ninth modification example illustrated in FIG. 5D and the tenth modification example illustrated in FIG. 5E, the enlarged portion 32b is formed in a serrated shape (sawtooth shape). In the ninth modification example, the irregularities formed on the outer periphery of the enlarged portion 32b have a square shape. In the tenth modification example, the irregularities formed on the outer periphery of the enlarged portion 32b have a smooth shape.

The third to tenth modification examples described above also exhibit substantially the same effects as the embodiment shown in FIG. 2B. The first to tenth modification examples are examples of the enlarged portion 32b and are not limited to the illustrated shapes.

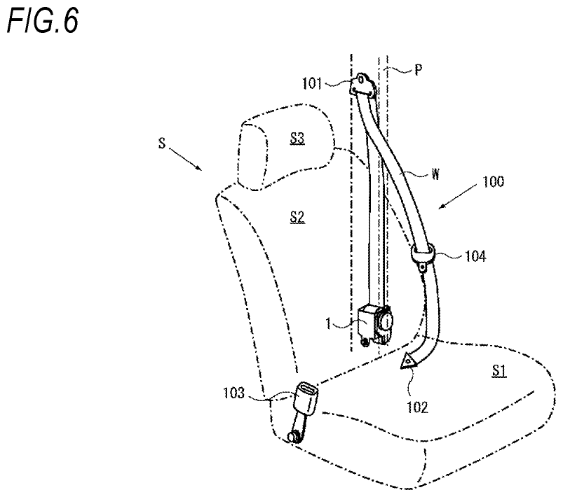

Next, a seat belt device according to an embodiment of the invention will be described with reference to FIG. 6. Here, FIG. 6 is an overall configuration diagram illustrating the seat belt device according to the embodiment of the invention. In FIG. 6, for convenience of explanation, components other than the seat belt device are illustrated by dashed lines.

A seat belt device 100 according to the embodiment illustrated in FIG. 6 includes a webbing W to restrain an occupant, the retractor 1 for winding the webbing W, a guide anchor 101 provided on the vehicle body side for guiding the webbing W, a belt anchor 102 for fixing the webbing W to the vehicle body side, a buckle 103 arranged on the side surface of a seat S, and a tongue 104 disposed on the webbing W. The retractor 1 has, for example, the configuration illustrated in FIG. 1.

Hereinafter, components other than the retractor 1 will be briefly described. The seat S includes, for example, a seat portion S1 on which an occupant sits, a backrest portion S2 located on the back of the occupant, and a headrest portion S3 for supporting the head of the occupant. The retractor 1 is built in, for example, a B pillar P of a vehicle body. In general, the buckle 103 is often arranged on the side surface of the seat S1 and the belt anchor 102 is often arranged on the lower surface of the seat S1. Further, the guide anchor 101 is often arranged on the B pillar P. The webbing W has one end connected to the belt anchor 102 and the other end connected to the retractor 1 via the guide anchor 101.

Therefore, when the tongue 104 is fitted to the buckle 103, the webbing W is pulled out from the retractor 1 while sliding in the insertion hole of the guide anchor 101. Further, when the occupant wears the seat belt or releases the seat belt at the time of dismounting, the webbing W is wound up by the spring unit 4 of the retractor 1 until a certain load is applied.

The seat belt device 100 described above is obtained by applying the retractor 1 according to the embodiment described above to a normal seat belt device in a front seat. Therefore, according to the seat belt device 100 of the embodiment, by forming the enlarged portion 32b at the tip end of the power transmission member 32a, it is possible to achieve both the securing of the strength of the power transmission member 32a in the initial driving stage and the reduction of the sliding resistance to the power transmission member 32a in the steady driving stage.

The seat belt device 100 according to the embodiment is not limited to application to a front seat and can be easily applied to a rear seat, for example, by omitting the guide anchor 101. Further, the seat belt device 100 according to the embodiment can be used for vehicles other than automobiles.

The invention is not limited to the embodiments described above and it goes without saying that various modifications can be made without departing from the spirit of the present invention.

### REFERENCE SIGNS LIST

1 retractor
2 spool
3 pretensioner
4 spring unit
5 lock mechanism
6 vehicle sensor
11 base frame
21 torsion bar
31 ring gear
31a engagement teeth
32 power transmission device
32a power transmission member
32b enlarged portion
32c pipe
32d gas generator
32e piston
32g opening portion
32h transition portion
32i outer peripheral edge portion
32j cylindrical portion
32k spherical portion
32m conical portion
32n frustoconical portion
33 pretensioner cover
34 guide spacer
34a stopper surface
35 guide block
35a slope
35b main body portion
36 fixing pin
51 retainer cover
52 locking base
53 lock gear
100 seat belt device
101 guide anchor
102 belt anchor
103 buckle
104 tongue
111, 112 end surface
111a, 112a, 112b opening portion
113 side surface
114 tie plate

1. A pretensioner comprising:
a ring gear connected to a spool which is configured to wind a webbing that is configured to restrain an occupant; and
a power transmission device which transmits power to the ring gear in an emergency, wherein
the power transmission device includes a rod-shaped power transmission member which is configured to transmit power to the ring gear while plastically deforming,
a tip end of the power transmission member has an enlarged portion which is formed thicker than other portions of the power transmission member, and
the enlarged portion is made of the same material as the power transmission member.

2. The pretensioner according to claim 1, wherein
the enlarged portion is formed such that a length in an axial direction of the power transmission member is smaller than a pitch of the ring gear.

3. The pretensioner according to claim 1, wherein
a guide block arranged at a meshing start portion between the ring gear and the power transmission member is provided, and
the guide block has a slope for guiding movement of the power transmission member and a main body portion fixed to a base frame surrounding the spool.

4. A retractor comprising a spool configured to wind a webbing to restrain an occupant and a pretensioner configured to wind the webbing to remove slack in an emergency, wherein
the pretensioner is the pretensioner according to claim 1.

5. A seat belt device comprising a webbing configured to restrain an occupant and a retractor configured to wind the webbing, wherein
the retractor includes the pretensioner according to claim 1.
